(19) United States
(12) Patent Application Publication
(10) Pub. No.: US 2007/0272070 A1
(43) Pub. Date: Nov. 29, 2007

(54) "Paladin" microphones - transducers for gloves and finger sheaths

(76) Inventor: Clennon Oscar McGinnis II, Portland, OR (US)

Correspondence Address: Clennon Oscar McGinnis II, 8 N.W. 8th Avenue #601, Portland, OR, 97209, US

(21) Appl. No.: 11/432,695

(22) Filed: May 12, 2006

(51) Int. Cl. G10D 7/12

(52) U.S. Cl. 84/378

(57) ABSTRACT

A hand adaptive microphone—transducer gloves in FIG. (3B) and FIG. (4B) comprises a gloved member adapted to be worn on a person hand. FIG. (3B) has an STD½″ Piezo Film Tab pickup with a ¼ “audio adapter in this illusion. FIG. (4B) has an STI1″ Piezo Film Tab pickup with a ⅛″ audio adapter in this illustration.

A hand adaptive microphone—transducer single finger sheaths that comprises of a K&K Hot Spot contact pickup with a ⅛″ audio jack, this is a (single sensing element) as illustrated in FIG. (1A) FIG. (2A) comprises of two single finger sheaths that has a K&K Twin Spot contact pickups with a ⅛″ audio jack, this is a (dual sensing elements). FIG. (1) is the illustration of the Hot Spot pickup (single sensing element. FIG. (2) is the illustration of the Twin Spot contact pickups with (dual sensing elements). FIG. (3) is the illustration of the STD½″ Piezo Film Tab pickup with a ¼″ audio jack. FIG. (4) is the illustration of the STD1″Piezo Film Tab pickup with a ⅛″ audio jack. These different configurations of this microphone—transducer; are extremely versatile and can be used many different ways with our gloves and our single finger sheaths. The Piezo's produces a signs when they are attached to a vibrating surface. The Piezo's and the Hot Spots and the Twin Spots are sensitive enough that they can pick up air vibrations from many wind instruments. The instrument that we will be using our invention with will be a harmonica which is a wind and a reed instrument that is usually held in the left or the right hand of the user. The Piezo, the Hot Spot, and the Twin Spots will be attached to the body of the gloves, and the single finger sheaths, the Piezo, the Hot Spot and the Twin spots can be attached by any of several means continued on page 6.

### CROSS-REFERENCE TO UNITED STATES PATENT

CROSS - REFERENCE TO UNITED STATES PATENT

| | | |
|---|---|---|
| 5486112 | JANUARY 1996 | TROUDET ET AL. |
| 60044153 | MARCH 2000 | KASCHKE |

### FEDERALLY SPONSORED RESEARCH

NOT APPLICABLE

### SEQUENCE LISTING OR PROGRAM

NOT APPLICABLE

### BACKGROUND OF THE INVENTION—FIELD OF INVENTION

This invention relates to the Shure® green bullet microphone or the Stinad® microphones for playing Hohner® Harmonicas that are used for playing amplified music.

### BACKGROUND OF THE INVENTION

Music stores and instrument manufactures commonly supply the consuming novice, semi-professional and professional harmonica players with microphones and transducers that they can play their harmonicas into. Such microphones and transducers are used for other applications. Patent Application of Clennon O. McGinnis II. & Thomas Butori for “The Paladin Microphone and Transducers for Gloves and finger Sheaths” continued on page 2.

Originally these microphones and transducers were used with short wave and ham radios so that the operators could communicate with one another. However these microphones and transducers are cumbersome and can affect the dexterity of both hands when one is playing his instruments and one is restricted by a length of cable.

Therefore, inventors have not created any new types of microphones and transducers that will allow better flexibility and mobility in such a way that leaves the performer much more relaxed and creative in their desired performance. U.S. Pat. No. 5,486,112 to Troudet et al. (1996) and U.S. Pat. No. 60,044,153 to Kaschke (2000) discloses a complex telephone glove which is expensive to construct which is made of different metals and plastics which is not effective for our use. These are the only patents that can be referenced we can not use any of these designs.
(a) Our manufacturing of the harmonica gloves and single finger sheaths require the use of leather of choice it will be supple very attractive to look at and feel. Suede, Persian, kid, capeskin, real or imitation pigskin, chamois, buckskin, cabretta, calfskin, deerskin, doeskin, goatskin, mocha, kidskin.
(b) Also polyester®, nylon®, and spandexg, these materials are already in fabric stores and leather shops and are readily available at a reasonable price, or at bulk from the manufactures at a better selection in choices of textures, colors, and prices.
(c) This will keep the price of making the gloves functional at an affordable price range even after the microphone and transducers are attached to the gloves and the single finger sheaths.
(d) The printing of the logo “The Paladin Harmonica Glove “will not be easily erased from the materials fore listed in (a) and (b) as to prevent patent infringements after the logo and trademark is registered at the same time we apply for our patent. So that a dishonest consumer can not remove our logo and trademark and then attache it to another or similar item without giving any evidence of doing so.

### BACKGROUND OF INVENTION—OBJECTS AND ADVANTAGES

Accordingly, besides the objects and advantages of the gloves and the single finger sheaths with the microphones and transducers described in our above patent, several objects and advantages of the present invention are:
(a) To provide gloves and single finger sheaths that has microphone and transducers of our selections that will be attached to these units of various densities, textures, in a variety of colors without requiring any other materials for the production of the gloves and the single finger sheaths and the microphones and transducers;
(b) To provide a gloves and single finger sheaths with microphone and transducers which is flexible;
(c) To provide a gloves and single finger sheaths with microphone and transducers of superior quality;
(d) To provide a gloves and single finger sheaths with microphone and transducers with superior surfaces for the reception of labeling or printing of registered logo and trademark;
(e) To provide a gloves and single finger sheaths with microphone and transducers whose labeling cannot be altered;
   Patent Application of Clennon O. McGinnis II. And Thomas E. Butori for “The Paladin Microphone-Transducers for Gloves and Single Finger Sheaths” continued on page 3.
(f) to provide a gloves and single finger sheaths with microphone and transducers which will not be slippery when handled with wet or greasy fingers;
(g) To provide a gloves and single finger sheaths with microphone and transducers which makes these items tamper-proof.

Further objects and advantages are to provide a gloves and single finger sheaths with microphone and transducers which can be used easily and conveniently with any harmonica which is simple to use and inexpensive to manufacture, which can be supplied as separate units, which can be used repeatedly, and which obviates the need to have an option of a different miking source. Still further objects and advantages will become apparent from a consideration of the ensuing description and drawings.

### SUMMARY

In accordance with the present invention a gloves and single finger sheaths comprises a microphone or a transducer that is attached to the units for ease of use once they are removed from the packaging or their storage cases. A first microphone, transducer adapted to be coupled to amplifier or public address system and carried by the gloves and the single finger members at a location on the inside of the palm of the hand and on the index finger, for single miking or on the index and the thumb for dual miking. When the gloves and the single finger members is worn on the hand of the person to permit a mouth of the person to blow acoustic signals into the microphone, transducers when the hand of the person is held against the mouth of the person.

### DRAWINGS—FIGURES

In the drawings, closely related figures have different numbers and different alphabetic suffixes.

FIGS. 1 thru 4 Shows various configurations of a microphone or transducer that we will be using in our invention.

FIG. 1 shows a K&K Hot Spot contact pickup, this is a single sensing element with a ⅛″ audio jack. p FIG. 2 shows a K&K Hot Spot contact pickup, this is a dual sensing element with a ⅛″ audio jack.

FIG. 3 shows a STD-1″ Piezo Film Tab with a ¼″ audio jack.

FIG. 4 shows a STD-2″ Piezo Film Tab with a ⅛″ audio jack.

FIG. 5 shows a side view of the hand with the single finger sheath with a pickup.

FIG. 6 shows a side view of the hand with the forefinger and the thumb with the single sheaths and with pickups.

FIG. 7 shows the palm of the hand with the Piezo Film Tab on the gloves.

FIG. 8 shows the palm side of the hand with the Piezo Film Tab on the index finger of the gloves.

### Patent Application of Clennon O. McGinnis II. & Thomas E. Butori for “The Paladin microphone-transducers for gloves an finger sheaths” continued on page 4.

### DETAILED DESCRIMTION OF TE P ERRED EMBODIMENT

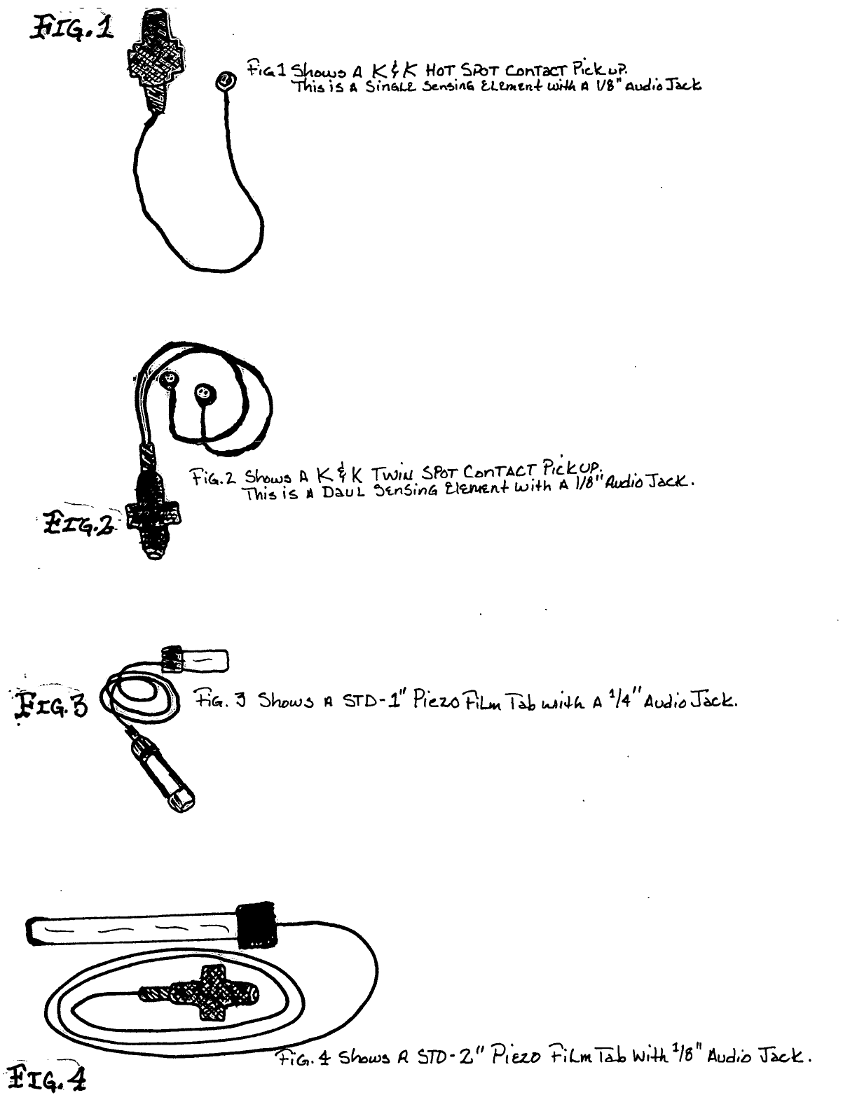

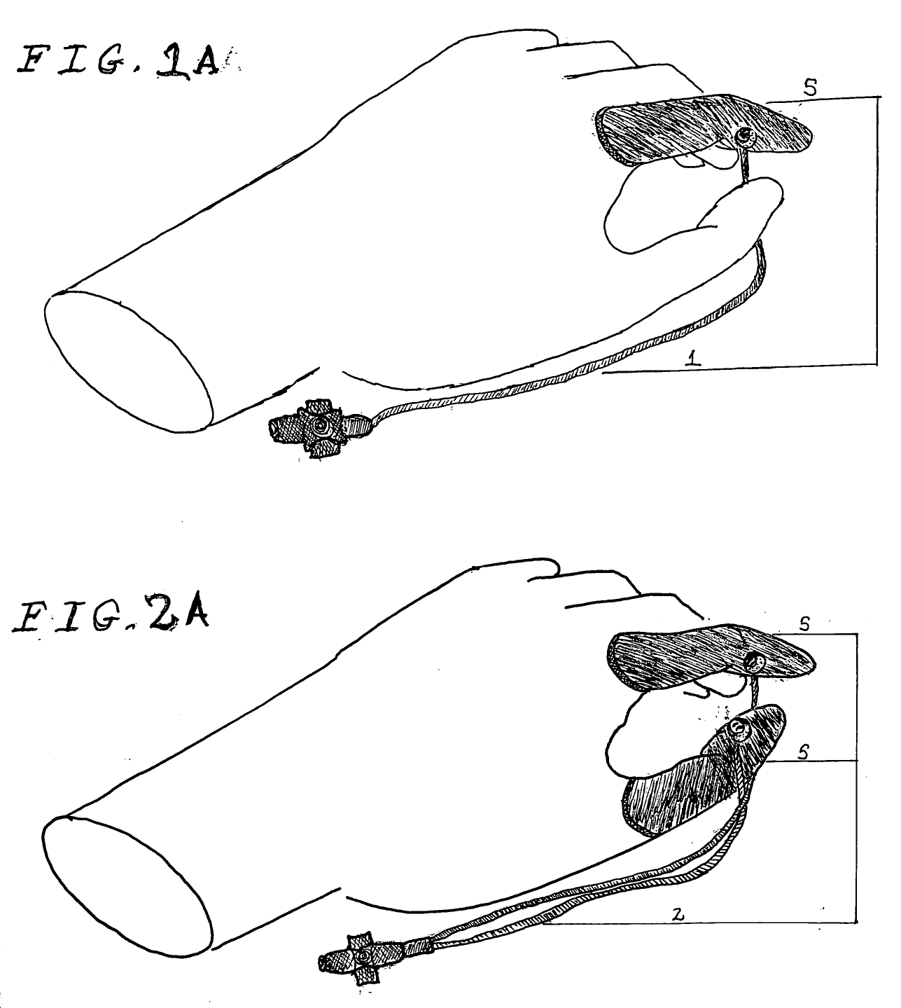

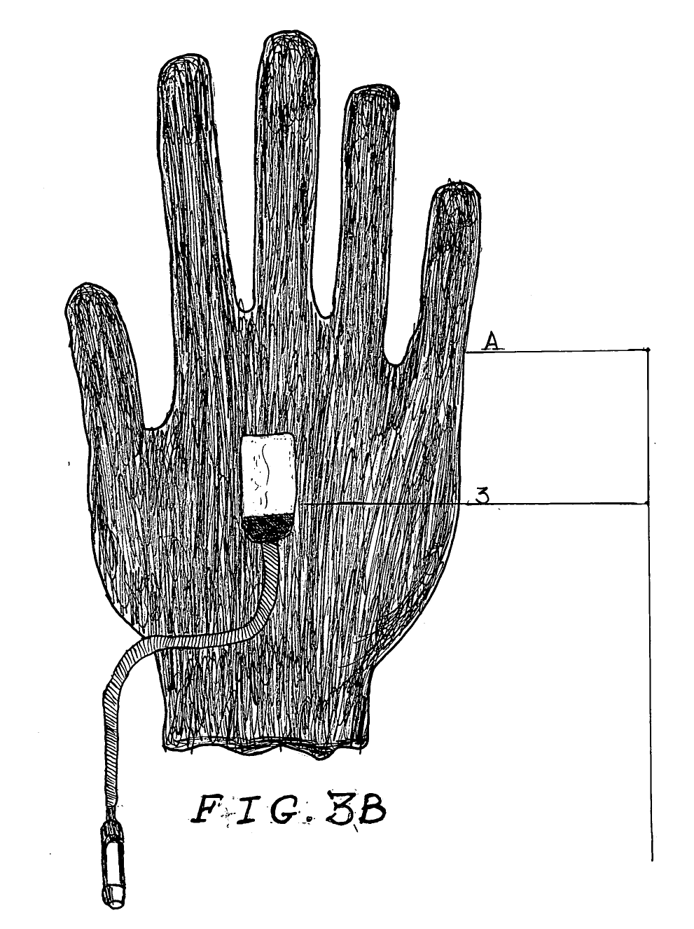

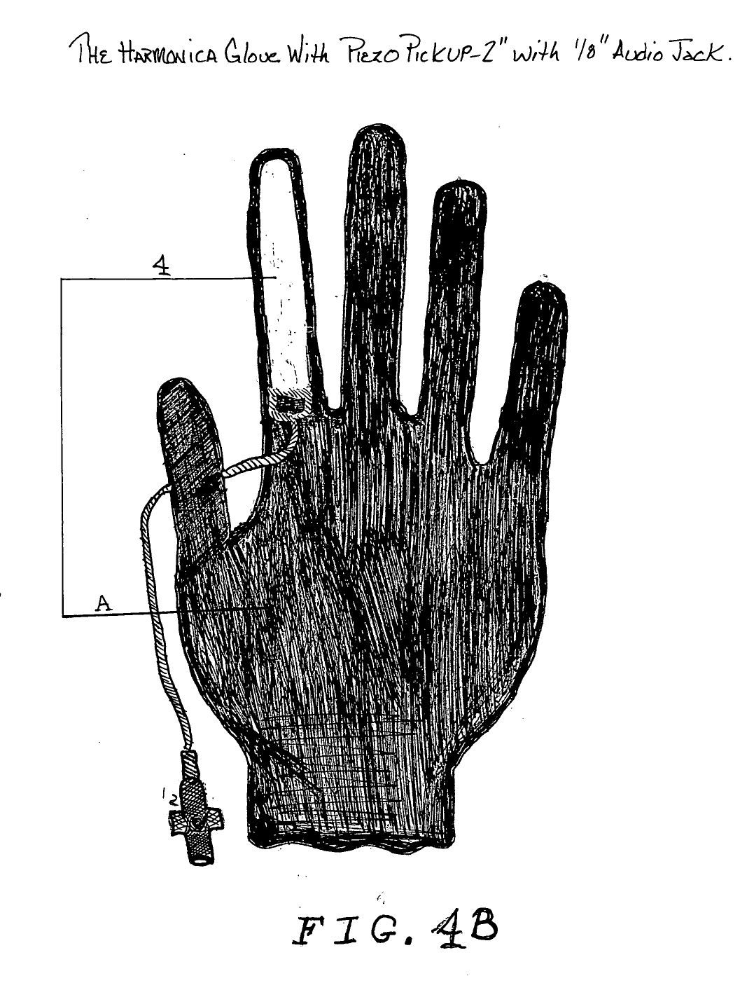

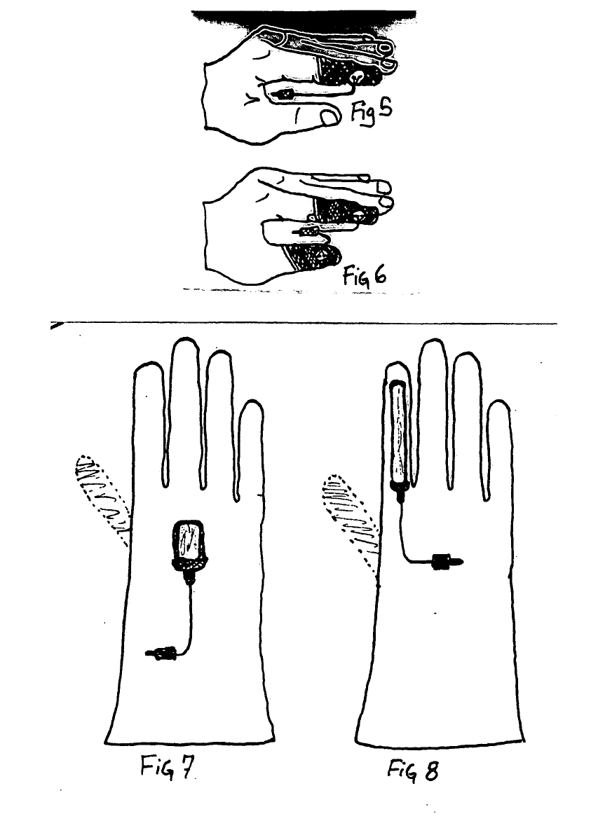

A preferred embodiment of the microphone-transducers of the present invention is illustrated in FIG. 1A (top view) and FIG. 2A (top view) and FIG. 3B (top view) and FIG. 4B (top view). The gloves and single finger sheaths FIGS. 5, 6 are made of materials that are supple and can be repeatedly worn for long periods of time with minimal wear. FIG. 5 are made of leathers, and FIG. 6 are made of nylon, polyester, and spandex for the single fingers sheaths these materials are found at our local stores in the cities where we live. FIGS. 5 & 6 show the various possibilities with the relative disposition of the side view of the hand and the palm view of the hand with the gloves and the single finger sheaths, this illustrates where they can be placed.

### CONCLUSION, RAMIFICATIONS, SCOPE

The user of this invention will be able to immediately use this invention with little or no learning curve the user will see that it is easy and covenant to use and to store not requiring a lengthy period of time to do either function. This invention permits immediate change of use of any desired application when used with a harmonica. Although the description above contains much specificity, these should not be construed as limiting the scope of the invention but as merely providing illusions of some of the presently preferred embodiments of this invention. For example, the microphones—transducers can have other shapes, such as circular, oval, tapezoidal, triangular, etc.; Thus the scope of the invention should be determined by the appended claims and their legal equivalents, rather than by the examples given continued on page 5.

We claim what is claimed is:

1. A hand adaptive microphone Glove and finger sheaths comprising:
A glove member adapted to be worn on a hand or a finger of a person; and
A series of microphones-transducers that are configured and coupled with different gloved adaptations
A series of microphones-transducers can also be attached to the instrument such as a harmonica as well as other applications
A harmonica glove with the microphone-transducers will be coupled with an amplifier or a public address system so that it can produce acoustic signals that will be audible
A person will put the harmonica in the hand with the harmonica glove or the single finger sheaths with the microphone-transducers and as they blow into the harmonica the person will produce acoustic signals that will be audible through the powered systems
